(19) United States
(12) Patent Application Publication
(10) Pub. No.: US 2026/0336974 A1
(43) Pub. Date: Oct. 29, 2026

(54) NOTIFICATION DEVICE AND METHOD FOR AN ELEVATOR

(71) Applicant: Inventio AG, Hergiswil (CH)

(72) Inventors: Ivo Lustenberger, Buttisholz (CH); Martin Hess, Baar (CH); Jean-Luc Schaer, Inwil (CH); David Michel, Rotkreuz (CH)

(21) Appl. No.: 18/997,194

(22) PCT Filed: Jul. 4, 2023
(86) PCT No.: PCT/EP2023/068352

§ 371 Date: Jan. 21, 2025

(30) Foreign Application Priority Data
Jul. 27, 2022 (EP) 22187268.2

(51) Int. Cl. B66B 5/00; B66B 3/00

(52) U.S. Cl. CPC B66B 5/0087; B66B 3/002

(57) ABSTRACT

A notification device and a notification method for an elevator are utilized for notifying a maintenance for the elevator. At least one of the notification devices is provided with a display and an information displayed by the one notification device is changed according to the current operation status of the elevator. The display is switched automatically off or to display a first information when the elevator is switched into its first operation mode, wherein the first information concerns a process to be executed for the elevator, and the display is switched automatically to display a second information when the elevator is switched into its second operation mode, wherein the second information is provided to help performing the process.

### FIELD

This invention relates to a notification device and a notification method for an elevator, especially for notifying a maintenance for the elevator, and an elevator that comprises such a notification device or is operated by this notification method.

### BACKGROUND

An elevator may comprise an elevator car that is movable vertically in an elevator shaft (hoistway) and may stop at different floors of a building. At present, more and more elevators do not need machine rooms anymore and can be constructed as machine-room-less (MRL) elevators. Many components including the operation-mode switch of the control system of an elevator are arranged on the top floor next to the landing doors. These components are assembled and locked within a cabinet which can be unlocked using a key for maintenance, repair or emergency purposes, etc. Such a cabinet is only accessible for authorized people. As a lot of important control devices are arranged or installed inside of this control cabinet, a maintenance person has to open the door of the control cabinet before starting maintenance or inspection work and then switch this elevator in a maintenance operation mode. During maintenance work on an elevator, passengers may not use this elevator.

Usually, a notification letter will be sent to the resident living in a building in advance to notify them of scheduled maintenance working for an elevator in this building. For an ordinary elevator, before a technician starts maintaining the elevator, he will put up a signboard or stick a label before every shaft door of the elevator in order to notify passengers that this elevator is currently out of service. After working, he has to take the signboards or labels piece to piece away. Sometimes there could be one or several boards or labels left which are forgotten to be removed.

Nowadays more and more elevators are provided with destination floor registering apparatus outside of elevator cars in a hall or lobby of a building. Such a destination floor registering apparatus may be provided as an operation panel via which passengers may give their destination floors. In this case, the operation panel is called LOP (landing operation panel) or Port. For example, a LOP can be switched in a normal notification mode for notifying a user of information relating to an operation of a car and in an inspection-information notification mode for notifying an inspection operator of inspection information corresponding to information for inspecting the elevator.

As elevators are applied to transport passengers along vertical distances, strict safety requirements have to be fulfilled. Elevator maintenance is performed by service personnel to keep elevator systems running safely. Concerning this, a set of elevator technical features has to be checked by service personnel regularly and especially before beginning with maintenance or inspection work. For example, a technician should test and check the effectiveness and functions of safety devices of an elevator to prove whether such devices are available and in good working conditions. Therefore, necessary procedures like safety precautions or a checklist should be executed before carrying out an elevator maintenance task. Hopefully, the technicians can be reminded or instructed to perform the necessary procedures. On the other hand, such a procedure could be complex and different for each elevator so that the technician cannot always know exactly what they have to do, even if he/she is sufficiently qualified. However, a disadvantage of an aforementioned simple electronic notification is that the LOP indicates only the current operation mode of an elevator. And passengers may just recognize whether the elevator at the moment is available or not, but they do not know how long this state will last, or how often it usually happens.

### SUMMARY

Accordingly, the invention of the present patent application aims to pursue a notification possibility to optimize the maintenance working for an elevator and also may improve user experience. Such an object may be achieved by the subject-matter of the advantageous embodiment evident from the following description.

According to the first aspect of the present invention, it relates to a notification device for an elevator. The notification device comprises a display, wherein an information displayed on the display is dependent on an operation status of the elevator. Furthermore, the notification device is configured in this art that the display is switched automatically off or to display the first information when the elevator is in the first operation mode of the elevator, wherein the first information concerns a process to be executed for the elevator, and the display is switched automatically to display the second information when the elevator is in the second operation mode of the elevator, wherein the second information is provided to help performing the process. By such a notification device it is possible to inform passengers and the residents in the building in advance of a procedure to be carried out in the next time, which may affect the use of the elevator. Therefore, the users of the elevator can make corresponding preparations in advance. And if the elevator is switched in the second operation mode, for example, the useful help information, instruction or warning messages can be provided.

According to an embodiment, the first operation mode is the normal operation mode of the elevator, while the second operation mode is the maintenance operation mode of the elevator, and the process to be executed can be a maintenance process or a safety process of the elevator. With the aforementioned notification device, the service person does not need anymore to manually notify passengers of information like “Elevator under Maintenance” on every floor. The second information may announce or instruct passengers that the elevator is currently out of service, and/or the first information may announce that the elevator can not be used soon in a given time period. On the other hand, when the elevator needs to be maintained, the service personnel can get relevant help information before beginning the maintenance or during the maintenance work. For example, to begin a maintenance activity, a service person has to execute a checklist. In the meanwhile, the notification device may notify the unavailability of the elevator in order to avoid passengers waiting outside of the car of this elevator.

According to a further embodiment, the notification device can be allocated outside of a shaft or inside of the car of the elevator. Accordingly, the notification device is attachable to or integratable into a landing operation panel (LOP) or a car operation panel (COP) of the elevator. For this embodiment, the notification device does not need its own display if the LOP/COP comprises a display unit. The information can be displayed on the LOP/COP according to the current operation mode of the elevator and/or to a planned process for the elevator. With the notification device, multiple different messages can be displayed in a predetermined order or in a determined area on the display. For example, a notification to passengers “maintenance is in progress” is displayed to indicate that the elevator is not available.

According to another embodiment, the notification device is able to communicate with a remote server, a remote center, and/or a controller of the elevator for acquiring a first and/or a second information. In this way, the notification device does not need to comprise its own storage unit. This kind of notification device is suited to be used anywhere in the elevator and in any kind of elevators. The remote center or the controller of the elevator may send the actual message immediately to the notification device, or vice versa. And the notification device may also act as an interface for the elevator to communicate with external environment (e.g. via Ethernet or Internet), if the elevator is not able to do this.

According to another embodiment, the notification device comprises a means to generate an audio or a haptic signal. The audio or the haptic signal is transformed e.g., from the information displayed by the notification device so that a blind person or kids and illiterates who struggle with reading may also realize that the elevator is currently not available. For example, when a blind person clicks or touches the display of the notification device, the notification device will generate a voice instruction according to the displayed information.

According to the second aspect of the present invention, it relates to a notification method for an elevator, wherein there is at least one notification device with a display. The information displayed by the notification device is changed according to a current operation status of the elevator in this manner that the display is switched automatically off or to display the first information when the elevator is switched into the first operation mode of the elevator, wherein the first information concerns a process to be executed for the elevator, and the display is switched automatically to display the second information when the elevator is switched into the second operation mode of the elevator, wherein the second information is provided to help performing the process.

According to an embodiment of the present invention, the first operation mode is the normal operation mode of the elevator, while the second operation mode is the maintenance operation mode of the elevator. Moreover, the process to be executed can be a maintenance process of the elevator. The notification device communicates with a remote server, a remote center and/or a controller of the elevator to acquire the first and/or the second information. An audio signal or a haptic signal is generated by the notification device according to the information displayed by the notification device.

According to an embodiment of the present invention, more than one notification device is allocated inside of the car of the elevator and/or outside of a shaft on one or different floors, and the first or the second information displayed on the notification devices are same or different from each other.

According to a further embodiment of the present invention, the first and the second information are displayed according to a specification or an identity (ID-code) of the elevator, especially in the native language of the elevator location, as elevators normally have to meet the relevant regulations of the region where they are located, as well as adapt to local customs, including language. Meanwhile, the customer experience can be thus improved. Additionally, the first or the second information can be also displayed as intuitive symbols that are generally clearly understandable for the customer.

According to another embodiment of the present invention, the first or the second information includes a machine-readable code, especially a bar code or QR-code, which is able to embed a hyperlink to a computer server, for example, for acquiring more information and data. The machine-readable code, for example, can be scant by a mobile device to let the mobile device access the elevator or a remote center or server which may communicate with the elevator. The user of the mobile device may be brought to a web page with more detailed information regarding the current elevator state (e.g., detailed failure information, time of failure, service support already informed, etc.). Such a code can also be used for verifying a service technician who is authorized to carry out the process planned for the elevator.

According to another embodiment of the present invention, the first information comprises information concerning a predictive message or a process planned for the elevator. Such a predictive message, for example, could be a maintenance or an inspection to be performed for an elevator at a next certain time. The planned process may concern a concrete procedure to be executed (e.g. a safety process or a checklist) for an elevator. It can be considered that such an information will not be displayed all the time, but only begin to display in advance from a certain time before a predefined time point or from the time point set for the planned process. For instance, besides that the current elevator state should be visible by scanning the QR-code, the next planned maintenance interval should also be displayed as extended customer support. This allows the customers to plan for using the elevator, for example, when they move. Advanced notification of elevator maintenance information is especially important for hospitals and factories. In such cases, the next maintenance date, time, and duration can be displayed. For a service person it is also helpful to take note of the next service interval when this information is visible on his/her smartphone when scanning the displayed QR-code.

A further aspect of the present invention relates to an elevator which may consist of one or more aforementioned notification devices.

At least one of the aforementioned implementations offers one or more solutions to the problems and disadvantages of the known prior art. Other technological benefits of the present invention become evident to a person skilled in the art from the following description and the claims. The numerous examples of implementing the present invention achieve only a part of the presented advantages. None of the advantages is critical to the examples of implementation. Any required embodiment can technically be combined with any other required embodiment. The examples represent only a few advantageous embodiments, and they do not limit the idea of the invention that can be implemented even in other manners within the framework of the claims presented further below.

### DESCRIPTION OF THE DRAWINGS

Below embodiments of the present invention are described in more detail with reference to the attached drawings. The accompanying drawings, which are included to provide a further understanding of the invention and constitute a part of this specification, illustrate embodiments of the invention and together with the description help to explain the principles of the invention. In the drawings:

FIG. 1 shows a schematic view of a front side of a notification device according to the aforementioned invention.

FIG. 2 shows a schematic view of an elevator with such a notification device.

### DETAILED DESCRIPTION

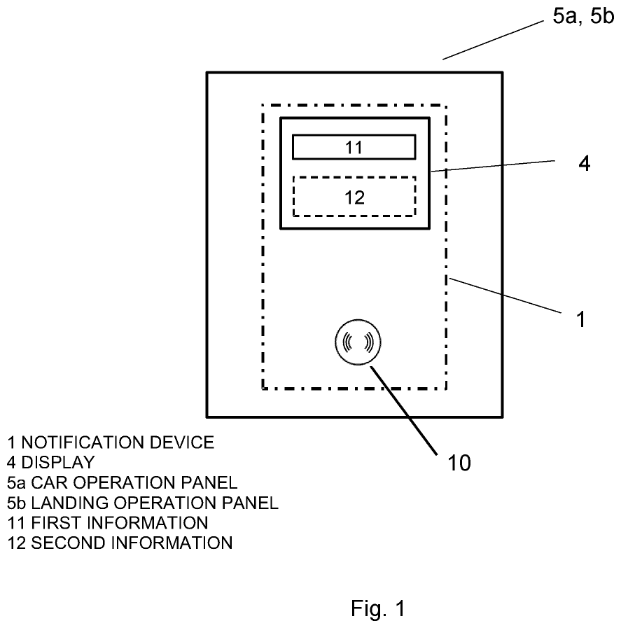

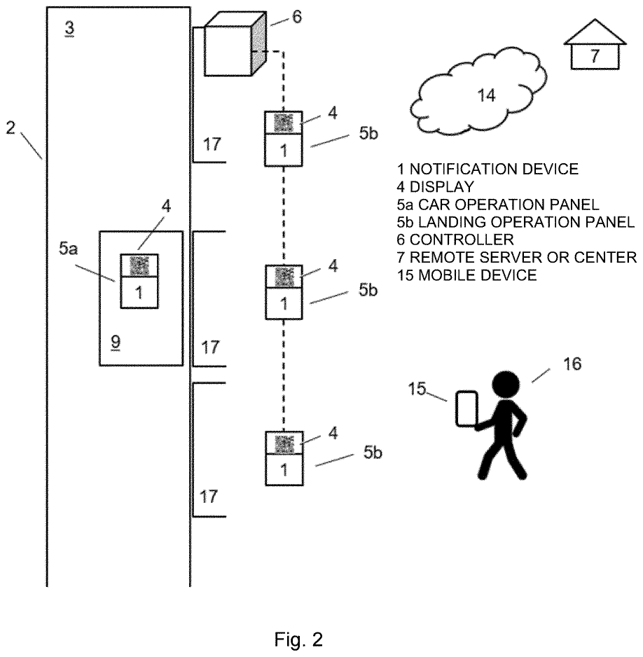

FIG. 1 is a schematic view of a front side of one example of a notification device 1 disclosed herein for an elevator 2 (see FIG. 2). For this embodiment, the notification device 1 comprises a display 4. To avoid that a blind person, illiterates, or kids who are not able to read or understand the displayed information, the notification device 1 is provided with a means 10 to generate an audio or a haptic signal. The means 10 could be a loudspeaker or vibrator. Alternatively, the display 4 may function as the means 10 too, if the display 4 is a touchscreen being able to generate a haptic signal. In this case, with a double-click on the display 4 or by pressing a special button 10, the notification device 1 will start to convert the displayed information into a voice instruction. For example, the voice is an artificial voice telling a passenger what is displayed.

The information displayed on the display is dependent on the operation status of the elevator 2. Particularly, the display 4 of the notification device 1 is switched automatically off or to display the first information 11 concerning a maintenance process to be executed soon, when the elevator 2 is in its normal operation mode. Passengers of the elevator 2 may know in advance that a maintenance process will be carried out in the next time. So they can prepare and plan in time for the case that the elevator is unavailable. The display 4 can be switched automatically to display the second information 12 when the elevator is in its maintenance operation mode. The second information 12 is help information to perform the planned maintenance process for this elevator 2. For example, the service personnel 16 (see FIG. 2) will get this help information to execute a complex checklist before beginning the maintenance process.

The notification device 1 can be integrated into an operation panel, e.g., a landing operation panel (LOP) 5b or a car operation panel (COP) 5a of an elevator 2. When the operation panel 5a, 5b comprises a display unit 4, the notification device 1 then does not need its own display 4. They may use the same display 4. With the notification device 1, multiple different messages can be displayed as the first 11 or the second information 12 in a predetermined order or in a determined area on the display 4. For example, a notification of “maintenance is in progress” indicates that the elevator 2 currently is not available for using.

As shown in FIG. 2, an elevator 2 is installed in a building and includes an elevator car 9 vertically movable in an elevator shaft 3. A controller 6 of the elevator 2, for example, is the main elevator controller which is also responsible for coordinating all aspects of elevator service. On every floor 17 of the building, a LOP 5b is provided, and in the elevator car 9 there is a COP 5a. The notification device 1 is integrated both in the LOP 5b and the COP 5a. Every one of these notification devices 1 can be coupled together or function individually. Therefore, the notification devices 1 may display the same or different information. In case that a blind person on a floor 17 knocks a notification device 1, then just this notification device 1 will generate an audio notification especially for this person.

The notification device 1 further can communicate with the controller 6 and also with a remote server 7 or a remote center 7 of the elevator 2 (e.g., via a network or the internet 14) for acquiring the first 11 or the second information 12. Hence, the notification device 1 may also act as an interface between the elevator 2 and the network 14 or the remote center 7, if the elevator 2 can not be connected directly with external environment. The first 11 or the second information 12 may be displayed in form of a QR-code, which is able to embed a hyperlink to a local storage unit (not shown) or the remote server 7. Such a code can be scant by a mobile device 15 so that the mobile device 15 may access the elevator 2 or the remote center/server 7 for getting more information. For instance, the user 16 of the mobile device 15 may get detailed information about/on the current elevator state (e.g., detailed failure information, time of failure, service support already informed, etc.). It may also show predictive message or predetermined information, e.g., advertising information, etc. The predictive message or the predetermined information may be not displayed all the time, but only in advance from a certain time before a predefined time point or from the time point set for the planned process. For example, the user 16 has to finish safety precautions (e.g., a checklist) at first. If the safety precautions are very complex, the user 16 can get instruction in how to finish the necessary safety precautions. Not only that the current elevator state is visible by scanning the QR-code, but also the next planned maintenance interval can be displayed, wherein the next maintenance date, time, and duration can be informed.

The first 11 or the second information 12 displayed on the notification devices 1 can be the same or the different information. Therefore, the first 11 or the second information 12 can be displayed according to the specific floor 17 or depending on the current position of the car 9. Accordingly, the information displayed by the notification devices 1 can be updated or refreshed synchronously or asynchronously. Furthermore, such a QR-code can be used also to verify the user 16 that is authorized to carry out the planned process of the elevator 2. The first 11 and the second information 12 can be displayed according to the location or identity (ID) of the elevator 2. So it is possible that the information is displayed in the native language of the elevator location. And the information can be also displayed as intuitive symbols that are generally clearly understandable for the customer.

It is to be understood that any of the above modifications can be applied singly or in combination to the respective aspects and/or embodiments to which they refer, unless they are explicitly stated as excluding alternatives. It is also obvious to a person skilled in the art that with the advancement of technology, the basic idea of the invention may be implemented in various ways. The invention and its embodiments are thus not limited to the examples described above; instead, they may vary within the scope of the claims.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A notification device for an elevator, the notification device comprising:
a display adapted to display information that is dependent on an operation status of the elevator;
wherein the display automatically switches off or to display a first information of the information when the operation status of the elevator is a first operation mode of the elevator, the first information representing a process to be executed for the elevator; and
wherein the display automatically switches to display a second information of the information when the operation status of the elevator is a second operation mode of the elevator, the second information providing help to a person to perform the process.

17. The notification device according to claim 16 wherein the first operation mode is a normal operation mode of the elevator, the second operation mode is a maintenance operation mode of the elevator, and the process is a maintenance process or a safety process to be executed for the elevator.

18. The notification device according to claim 16 wherein the notification device adapted to be allocated outside a shaft of the elevator and/or inside a car of the elevator.

19. The notification device according to claim 18 wherein the notification device adapted to be attached to or integrated into a landing operation panel of the elevator.

20. The notification device according to claim 16 wherein the notification device is adapted to communicate with a remote server, a remote center, and/or a controller of the elevator to acquire the first information and/or the second information.

21. The notification device according to claim 16 including a means to generate an audio signal or a haptic signal.

22. A notification method for an elevator, the method comprising steps of:
operating a notification device with a display to change information displayed by the display according to a current operation status of the elevator;
automatically switching the display off or to display a first information of the information when the operation status of the elevator is a first operation mode of the elevator, the first information representing a process to be executed for the elevator; and
automatically switching the display to display a second information of the information when the operation status of the elevator is a second operation mode of the elevator, the second information providing to help to a person to perform the process.

23. The notification method according to claim 22 wherein the first operation mode is a normal operation mode of the elevator, the second operation mode is a maintenance operation mode of the elevator, and the process is a maintenance process or a safety process to be executed for the elevator.

24. The notification method according to claim 22 wherein the notification device includes a first notification device and a second notification device, the first notification device being allocated inside a car of the elevator and the second notification device being allocated outside a shaft of the elevator on a first floor of a building in which the elevator is installed, or the first notification device being allocated outside the shaft on a second floor of the building, and wherein the first information or the second information displayed on the first and second notification devices are same or different.

25. The notification method according to claim 22 wherein the notification device communicates with a remote server, a remote center, and/or a controller of the elevator to receive the first information and/or the second information.

26. The notification method according to claim 22 including generating an audio signal or a haptic signal from the notification device based upon the information being displayed by the notification device.

27. The notification method according to claim 22 including displaying the first information and the second information according to an identity of the elevator or a location of the elevator.

28. The notification method according to claim 27 including displaying the first information and the second information in a native language at the location of the elevator.

29. The notification method according claim 22 wherein the first information or the second information includes a machine-readable code.

30. The notification method according claim 22 wherein the machine-readable code is a barcode or QR-code, the barcode or the QR-code including an embedded hyperlink to a computer server.

31. The notification method according to claim 22 wherein the first information includes a predictive message or the process to be executed.

32. An elevator comprising:
an elevator shaft in a building;
an elevator car movable in the elevator shaft between floors of the building;
a plurality of notification devices each having a display adapted to display information that is dependent on an operation status of the elevator;
wherein one of the notification devices is installed in the car and others of the notification devices are installed at associated ones of the floors;
wherein each of the displays automatically switches off or to display a first information of the information when the operation status of the elevator is a first operation mode of the elevator, the first information representing a process to be executed for the elevator; and
wherein each of the displays automatically switches to display a second information of the information when the operation status of the elevator is a second operation mode of the elevator, the second information providing help to a person to perform the process.
